(19) United States
(12) Patent Application Publication
(10) Pub. No.: US 2026/0220180 A1
(43) Pub. Date: Jul. 30, 2026

(54) METHOD AND SYSTEM FOR CONSTRUCTING VISUALIZATION GRAPH BASED ON NATURAL LANGUAGE

(71) Applicant: PEKING UNIVERSITY, Beijing (CN)

(72) Inventors: Xiaoru YUAN, Beijing (CN); Can LIU, Beijing (CN); Ruike JIANG, Beijing (CN); Jie LIANG, Beijing (CN)

(73) Assignee: PEKING UNIVERSITY, Beijing (CN)

(21) Appl. No.: 19/144,539

(22) PCT Filed: Nov. 27, 2023
(86) PCT No.: PCT/CN2023/134379

§ 371 Date: Aug. 29, 2025

(30) Foreign Application Priority Data
Dec. 30, 2022 (CN) 202211724285.4

(51) Int. Cl. G06F 16/34

(52) U.S. Cl. CPC G06F 16/34

(57) ABSTRACT

A method and a system for constructing a visualization chart based on natural language are provided. The method includes: receiving, by an attribute-level model, natural language and data attributes as input, and predicting attributes and filters based on each of the data attributes; determining, by a context state machine, content to be visualized based on context and the predicted attribute and filter of a current sentence; and constructing, by a visualization generation module, a visualization chart based on an attribute and a filter to be visualized. The method parses the ambiguous and diverse natural language into data attributes and filter conditions based on deep learning, and constructs the visualization chart based on the extracted data attributes to respond to the user's natural language. The method lowers the barrier to data visualization, and possesses strong practicality and strong promotion potential.

### CROSS REFERENCE TO THE RELATED APPLICATIONS

This application is the national phase entry of International Application No. PCT/CN2023/134379, filed on Nov. 27, 2023, which is based upon and claims priority to Chinese Patent Application No. 202211724285.4, filed on Dec. 30, 2022, the entire contents of which are incorporated herein by reference.

### TECHNICAL FIELD

The present disclosure belongs to the field of visualization, and specifically relates to a method and a system for constructing a visualization chart based on natural language.

### BACKGROUND

As an important means to express data content, visualization can clearly and intuitively represent data characteristics. However, existing visualization creation tools require programming and other specialized expertise. Due to a high barrier to creation, visualization is difficult to popularize among the general public.

Language is a natural way to express needs, and the public naturally expresses their needs through language. However, natural language expression is ambiguous, and the same meaning has diverse expressions. The challenge in visualizing natural language lies in the ambiguity between the user's language and the visualization, as well as the selection of visualizations for different scenarios. Traditional natural language interfaces for visualizations require users to specify concrete data attributes and visual mappings and require users to adhere to specific rules to specify visualizations.

### SUMMARY

In view of the defects in the prior art, an objective of the present disclosure is to provide a method and a system for constructing a visualization chart based on natural language. The present disclosure proposes a deep learning-based method that parses natural language into data attributes and filter conditions and constructs a visualization chart based on the extracted data attributes to respond to the user's natural language.

To achieve the above objective, the technical solutions adopted by the present disclosure are as follows. In a first aspect, a method for constructing a visualization chart based on natural language includes following steps:
S1: receiving, by an attribute-level model, natural language and data attributes as input, and predicting attributes and filters based on each of the data attributes;
S2: determining, by a context state machine, an attribute and a filter to be visualized based on context and the predicted attribute and filter of a current sentence; and
S3: constructing, by a visualization generation module, a visualization chart based on the attribute and the filter to be visualized.

Furthermore, the step S1 includes: converting, by a sentence transfer model of the attribute-level model, the input into a unified vector representation; and inputting the vector representation to an attribute parser module and a filter parser module to predict an attribute and a filter for the input, respectively.

Furthermore, the sentence transfer model is pre-trained based on a training dataset, with attribute training and filter training separated.

Furthermore, the training dataset includes two parts: a first part being a numerical acquisition dataset WikiSQL adapted from a database domain and a second part being a dataset constructed based on a user behavior pattern of exploring tabular data.

Furthermore, the training dataset of the second part is constructed by: collecting a common expression for user exploration of tabular data and abstracting the common expression into a template, filling a certain quantity of table attributes into the template to generate a candidate sentence, and generating a large quantity of diverse sentences through back-translation.

Furthermore, the method includes: receiving, by the attribute parser module, a vector w from the sentence transfer model as input; generating a probability ranging from 0 to 1 based on the vector w; determining an aggregation type present in the attribute; determining a quantity of selected attributes; and selecting n attributes with a highest probability as selected predicted attributes.

Furthermore, the method includes: receiving, by the filter parser module, a vector w from the sentence transfer model as input; predicting a probability of a filter present in the attribute, an operation type of the filter, a filter value, and a quantity m of selected filters; and taking m filter conditions with a highest probability as selected predicted filters.

Furthermore, the step S2 includes: setting a context flag allowing a user to decide whether to inherit a context filter condition; setting an upper limit on the attributes, and sorting the attributes by probability and timeliness; and determining visualization content to be displayed.

Furthermore, the step S3 includes: determining an appropriate visualization type according to the user's perception ability of different attributes.

In a second aspect, a system for constructing a visualization chart based on natural language constructs a visualization chart by using the method for constructing a visualization chart based on natural language in the first aspect of the present disclosure and any optional implementation thereof.

The present disclosure has following beneficial technical effects. The present disclosure provides a method and a system for constructing a visualization chart based on natural language. The present disclosure parses the ambiguous and diverse natural language into data attributes and filter conditions based on deep learning and constructs the visualization chart based on the extracted data attributes to respond to the user's natural language. The present disclosure lowers the barrier to data visualization, possesses strong practicality, and lays the foundation for promoting visual data.

### BRIEF DESCRIPTION OF THE DRAWINGS

FIG. 1 is a flowchart of a method for constructing a visualization chart based on natural language according to Embodiment 1 of the present disclosure;

FIG. 2 is a schematic diagram of an attribute parsing process in the method for constructing a visualization chart based on natural language according to Embodiment 1 of the present disclosure;

FIG. 3 is a schematic diagram of a filter parsing process in the method for constructing a visualization chart based on natural language according to Embodiment 1 of the present disclosure;

FIG. 4 is a schematic diagram of a visualization result generated for multiple sentences in the method for constructing a visualization chart based on natural language according to Embodiment 1 of the present disclosure;

FIG. 5 is an interface diagram of a system for constructing a visualization chart based on natural language according to Embodiment 2 of the present disclosure; and

FIG. 6 is a schematic diagram of a visualization result generated for a sequence of a paragraph text in the system for constructing a visualization chart based on natural language according to Embodiment 2 of the present disclosure.

### DETAILED DESCRIPTION OF THE EMBODIMENTS

The present disclosure is further described below with reference to the drawings and specific implementations.

### Embodiment 1

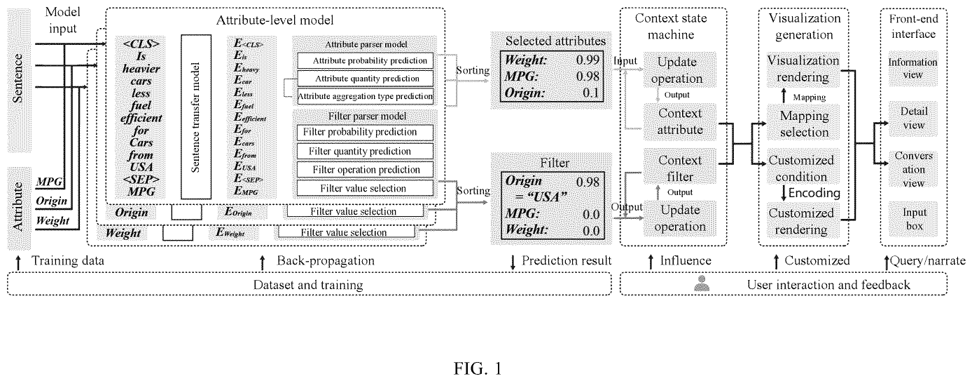

As shown in FIG. 1, the embodiment of the present disclosure provides a method for constructing a visualization chart based on natural language, including following steps.
S1. An attribute-level model receives natural language and data attributes as input, for example, one sentence and one attribute, as input, and generates predictions for each data attribute.

In the embodiment of the present disclosure, the input is converted into a unified vector representation through a large-scale pre-trained sentence transfer model of the attribute-level model. The vector representation serves as input to an attribute parser module and a filter parser module to predict attributes and filters.

The embodiment of the present disclosure constructs a training dataset. After training, the sentence transfer model possesses the capability to accurately extract attributes and filter conditions.

The training dataset includes two parts: a first part being a numerical acquisition dataset WikiSQL adapted from a database domain and a second part being a dataset constructed based on a user behavior pattern of exploring tabular data. Common expressions for user exploration of tabular data are collected and abstracted into templates. A large quantity (24000) of table attributes are filled into the templates to generate candidate sentences. Through back-translation, a large quantity of diverse sentences are obtained. The training process is conducted on a combined dataset of the two data. Since the sentence transfer model separates attribute and filter training, the trained sentence transfer model possesses the multi-filter extraction performance of WikiSQL and the multi-attribute extraction performance on the constructed dataset without conflict.

The large-scale pre-trained sentence transfer model is pre-trained on a large natural language corpus, thereby possessing strong generalization capability. The embodiment of the present disclosure converts the sequence combining the input sentence and attribute into an output vector sequence based on the pre-trained bidirectional encoder representations from transformers (BERT) model for subsequent deep learning tasks. The first vector w of this vector sequence represents information of the entire input sequence.

The attribute parser module receives the vector w from the pre-trained transfer model as input and predicts attribute probability, attribute aggregation type, and n selected attributes. An attribute probability prediction sub-module generates a probability from 0 to 1 based on the vector w. An attribute aggregation type prediction sub-module determines the aggregation type present in the attribute, selecting an option with a highest probability from “count”, “sum”, “average”, “max”, “min”, and “no aggregation”. A selection attribute quantity prediction sub-module determines a quantity of selected attributes, selecting a quantity from 0 to a maximum value as the selected quantity, which is also a classification problem. The attribute parser module selects the n attributes with the highest probability as the selected attributes based on the probability.

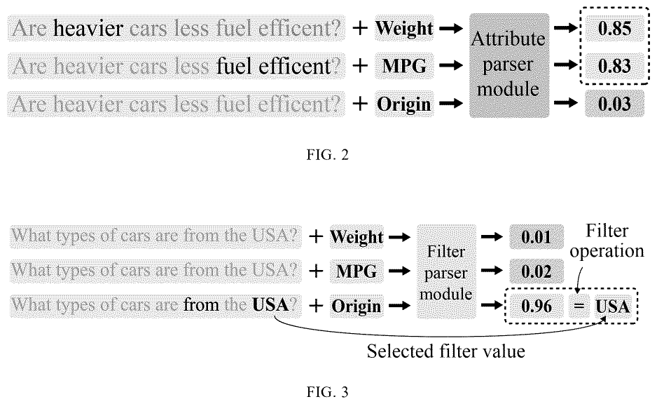

As shown in FIG. 2, the attribute parser module predicts the probability of the attribute being selected and the selected quantity through the sentence and each data attribute. The probability of each attribute being selected ranges from 0 to 1, and finally the n attributes with high probability are selected.

The filter parser module receives the vector from the pre-trained transfer model as input and predicts a probability of a filter present in the attribute, an operation type of the filter, a filter value, and n selected filters. The prediction of the filter probability and filter quantity is similar to the prediction of the attribute probability and quantity. A filter condition prediction sub-module selects one filter condition from greater than, less than, and equal to, and acquires the filter value by selecting a start position and an end position from the input question.

As shown in FIG. 3, the filter parser module predicts the filter probability, the selected quantity, the filter condition, and the filter value through the sentence and each data attribute, and finally selects the filter condition with high probability.
S2. A context state machine determines attributes and filters requiring visualization based on attributes and filters selected by the context and the current sentence.

The context state machine receives the output of the attribute parser module and the filter parser module as input, and determines attributes and filter conditions requiring visualization based on context information. In sequential sentences, the context of preceding sentences may influence subsequent sentences. From the perspective of attributes and filters, there are mainly two types of subsequent statements: inheritance of filters and inheritance of selected attributes. A context flag is set to allow the user to decide whether to inherit context filter conditions. For attribute context inheritance, the present disclosure sets an upper limit on attributes, sorting them by probability and timeliness to determine the visualization content to be displayed.
S3. Based on the attributes and filters output by the context state machine, a visualization generation module decides the generated visualization result.

The visualization generation module selects an appropriate visualization for rendering based on the attributes and filters output by the context state machine. The visualization generation module determines the appropriate visualization type according to the user's perception ability of different attributes, allowing multiple visualization rendering engines to draw a visualization chart.

Besides common charts, the method for constructing a visualization chart based on natural language provided by the embodiment of the present disclosure offers a user customization interface. The customization interface includes two parts: rendering conditions and rendering functions. When rendering conditions are met, rendering functions are used for rendering. Rendering conditions and rendering functions can access attributes (including their aggregation and value lists). Based on the data filtered by filters and the question, users can apply rendering conditions to attributes, filtered data, or the question themselves. In rendering functions, users can employ multiple different visualization tools for rendering.

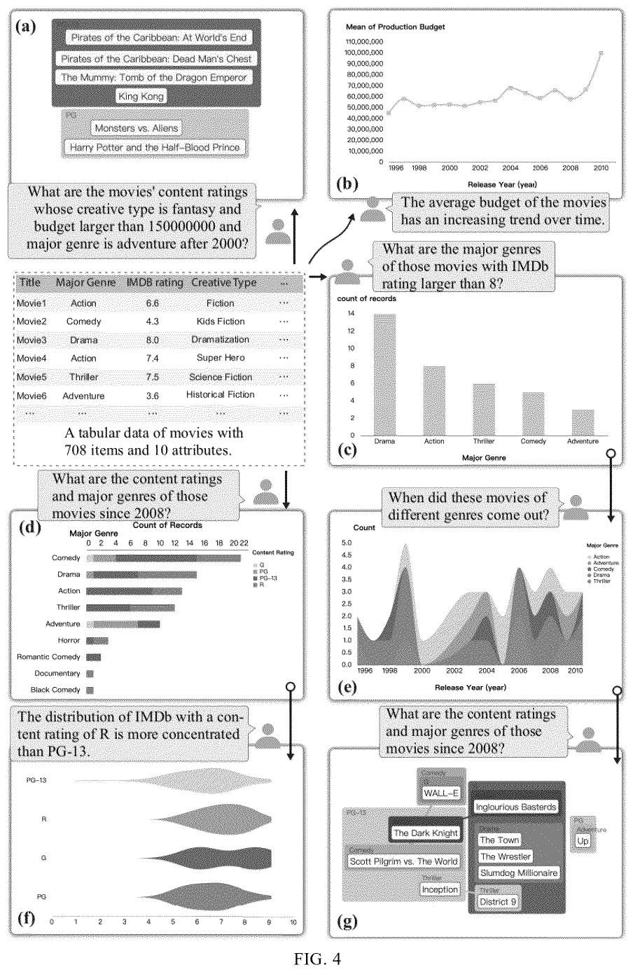

As shown in FIG. 4, the input is a movie dataset including 708 items and 10 attributes. The method for constructing visualizations based on natural language provided by the embodiment of the present disclosure supports visualizing multiple sentences. In (a), (c), and (d), single questions about the data are presented. In (b), a single narrative sentence is presented. In (c), (e), and (g), sequential questions about inheriting filters from preceding sentences are presented, supporting exploration of unfamiliar datasets. In (d) and (g), the same question in different contexts leads to different answers. From (d) to (f), the narrative sentence in (f) inherits the context filter from (d).

### Embodiment 2

The embodiment of the present disclosure provides a system for constructing a visualization chart based on natural language. The system visualizes the user's natural language by using the method for constructing a visualization chart based on natural language provided by Embodiment 1 of the present disclosure and any optional implementation thereof. The system includes the attribute-level model, the attribute parser module, the filter parser module, the context state machine, and the visualization generation module.

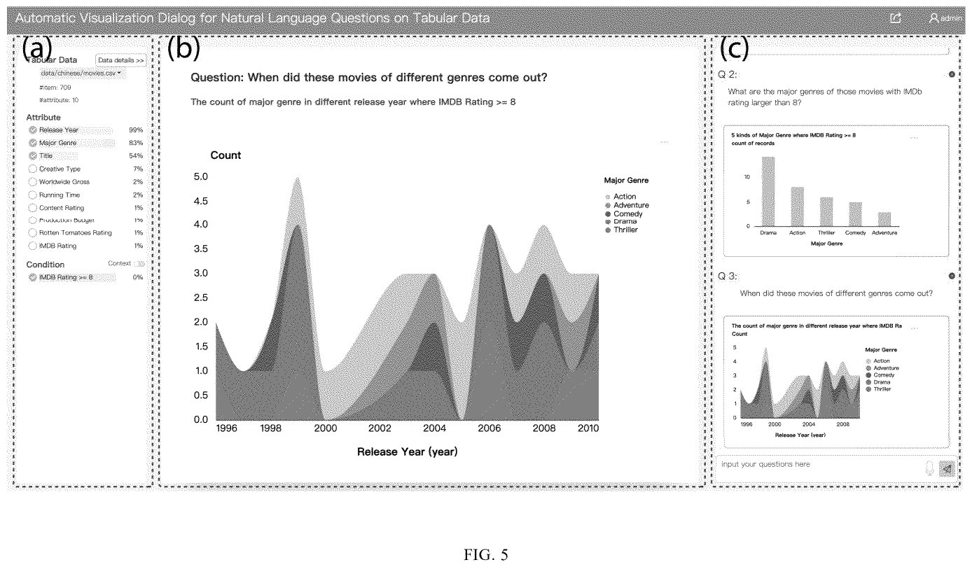

An interface of the system for constructing a visualization chart based on natural language provided by the embodiment of the present disclosure is shown in FIG. 5. The system allows the user to input multiple natural language expressions to obtain a visualization chart. The interface includes interface (a) for displaying attribute information and filter information, interface (b) for displaying visualization details, and interface (c) for displaying conversation history. In the input box, the user can input questions via voice or keyboard typing, and the corresponding visualization will respond promptly (average 0.1 seconds).

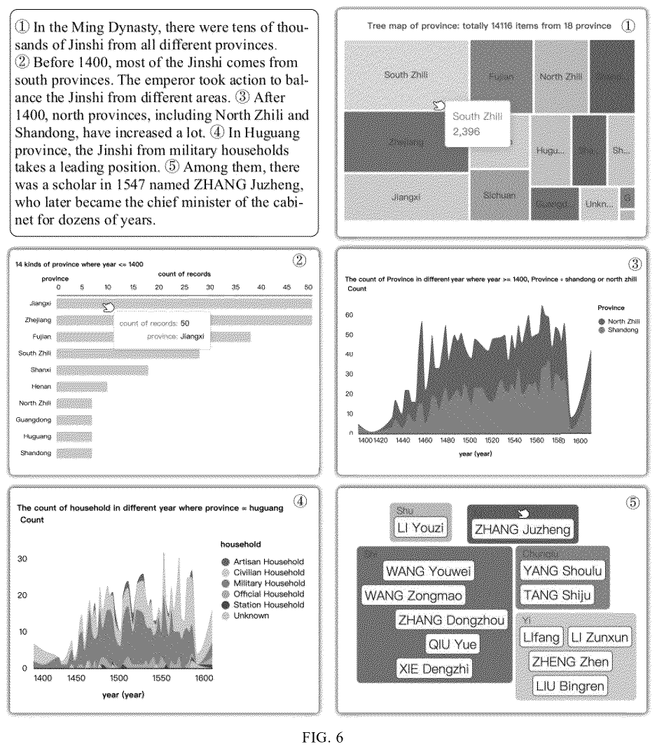

As shown in FIG. 6, when visualizing narrative sentences describing Ming Dynasty Jinshi in a paragraph, the system provided by the embodiment of the present disclosure generates corresponding visualization content for the sentences in the paragraph.

Through the above embodiments, it can be seen that the present disclosure provides a method and a system for constructing a visualization chart based on natural language. An attribute-level model receives natural language and data attributes as input, and generates predictions for each data attribute. A context state machine determines attributes and filters requiring visualization based on attributes and filters of the context and the current sentence. The visualization generation module constructs a visualization chart based on attributes and filter conditions requiring visualization. The method provided by the present disclosure parses the ambiguous and diverse natural language into data attributes and filter conditions based on deep learning and constructs the visualization chart based on the extracted data attributes to respond to the user's natural language. The present disclosure lowers the barrier to data visualization, possesses strong practicality, and lays the foundation for promoting visual data.

The method and system of the present disclosure are not limited to the embodiments in the detailed description. All other implementations obtained by those skilled in the art according to the technical solutions of the present disclosure should also fall within the technological innovation scope of the present disclosure.

What is claimed is:

1. A method for constructing a visualization chart based on natural language, comprising following steps:
S1: receiving, by an attribute-level model, the natural language and data attributes as input, and predicting attributes and filters based on each of the data attributes;
S2: determining, by a context state machine, an attribute and a filter to be visualized based on context and the predicted attribute and filter of a current sentence; and
S3: constructing, by a visualization generation module, the visualization chart based on the attribute and the filter to be visualized.

2. The method according to claim 1, wherein the step S1 comprises: converting, by a sentence transfer model of the attribute-level model, the input into a unified vector representation; and inputting the unified vector representation to an attribute parser module and a filter parser module to predict an attribute and a filter for the input, respectively.

3. The method according to claim 2, wherein the sentence transfer model is pre-trained based on a training dataset, with attribute training and filter training separated.

4. The method according to claim 3, wherein the training dataset comprises a first part and a second part, wherein the first part is a numerical acquisition dataset WikiSQL adapted from a database domain, and the second part is a dataset constructed based on a user behavior pattern of exploring tabular data.

5. The method according to claim 4, wherein the training dataset of the second part is constructed by: collecting a common expression for user exploration of the tabular data and abstracting the common expression into a template, filling a predetermined quantity of table attributes into the template to generate a candidate sentence, and generating a large quantity of diverse sentences through back-translation.

6. The method according to claim 2, wherein the method comprises: receiving, by the attribute parser module, a vector w from the sentence transfer model as input; generating a probability ranging from 0 to 1 based on the vector w; determining an aggregation type present in the attribute; determining a quantity of selected attributes; and selecting n attributes with a highest probability as selected predicted attributes.

7. The method according to claim 2, wherein the method comprises: receiving, by the filter parser module, a vector w from the sentence transfer model as input; predicting a probability of a filter present in the attribute, an operation type of the filter, a filter value, and a quantity m of selected filters; and taking m filter conditions with a highest probability as selected predicted filters.

8. The method according to claim 7, wherein the step S2 comprises: setting a context flag allowing a user to decide whether to inherit a context filter condition; setting an upper limit on the attributes, and sorting the attributes by probability and timeliness; and determining visualization content to be displayed.

9. The method according to claim 8, wherein the step S3 comprises: determining an appropriate visualization type according to the user's perception ability of different attributes.

10. A system for constructing a visualization chart based on natural language, configured to construct the visualization chart by using the method according to claim 1.

11. The system according to claim 10, wherein the step S1 of the method comprises: converting, by a sentence transfer model of the attribute-level model, the input into a unified vector representation; and inputting the unified vector representation to an attribute parser module and a filter parser module to predict an attribute and a filter for the input, respectively.

12. The system according to claim 11, wherein in the method, the sentence transfer model is pre-trained based on a training dataset, with attribute training and filter training separated.

13. The system according to claim 12, wherein in the method, the training dataset comprises a first part and a second part, wherein the first part is a numerical acquisition dataset WikiSQL adapted from a database domain and a second part is a dataset constructed based on a user behavior pattern of exploring tabular data.

14. The system according to claim 13, wherein in the method, the training dataset of the second part is constructed by: collecting a common expression for user exploration of the tabular data and abstracting the common expression into a template, filling a predetermined quantity of table attributes into the template to generate a candidate sentence, and generating a large quantity of diverse sentences through back-translation.

15. The system according to claim 11, wherein the method comprises: receiving, by the attribute parser module, a vector w from the sentence transfer model as input; generating a probability ranging from 0 to 1 based on the vector w; determining an aggregation type present in the attribute; determining a quantity of selected attributes; and selecting n attributes with a highest probability as selected predicted attributes.

16. The system according to claim 11, wherein the method comprises: receiving, by the filter parser module, a vector w from the sentence transfer model as input; predicting a probability of a filter present in the attribute, an operation type of the filter, a filter value, and a quantity m of selected filters; and taking m filter conditions with a highest probability as selected predicted filters.

17. The system according to claim 16, wherein the step S2 of the method comprises: setting a context flag allowing a user to decide whether to inherit a context filter condition; setting an upper limit on the attributes, and sorting the attributes by probability and timeliness; and determining visualization content to be displayed.

18. The system according to claim 17, wherein the step S3 of the method comprises: determining an appropriate visualization type according to the user's perception ability of different attributes.
